(19) United States
(12) Patent Application Publication
(10) Pub. No.: US 2026/0283408 A1
(43) Pub. Date: Sep. 24, 2026

(54) FOOD PREPARATION DEVICE FOR THE FREEZE-DRYING PROCESS

(71) Applicant: Patrick Sittnick, Hendersonvillle, TN (US)

(72) Inventor: Patrick Sittnick, Hendersonvillle, TN (US)

(21) Appl. No.: 19/086,804

(22) Filed: Mar. 21, 2025

(51) Int. Cl. A47J 43/28

(52) U.S. Cl. CPC A47J 43/28

(57) ABSTRACT

A food preparation device for use in preparing food during the freeze-drying process is disclosed. The food preparation device includes a handle configured to be gripped by a user and a yoke connected to the handle and extending outward to support a piercing assembly. The piercing assembly includes a plurality of rotatable star-shaped wheels mounted on an axle within the yoke, the star-shaped wheels configured to pierce a food item when the device is rolled over the food item. A comb is positioned adjacent to the plurality of star-shaped wheels, wherein the comb is angled to facilitate automatic removal of the food item from the plurality of star-shaped wheels without crushing or deforming the food item.

### TECHNICAL FIELD

The embodiments disclosed herein generally relate to food preparation tolls and, more particularly, to a device designed for piercing and removing fresh produce to facilitate the freeze-drying and dehydration processes.

### BACKGROUND

Freeze drying is a common method used to preserve food by removing moisture through sublimation. The process is more efficient when the food's skin is pierced, allowing water vapor to escape more effectively. Currently, there are no commercially available devices specifically designed for this purpose. As a result, food producers must manually puncture fruits and vegetables, leading to inconsistencies in drying quality and increased labor costs.

### SUMMARY OF THE INVENTION

This summary is provided to introduce a variety of concepts in a simplified form that is further disclosed in the detailed description of the embodiments. This summary is not intended for determining the scope of the claimed subject matter.

The embodiments provided herein relate to a food preparation device for use in preparing food during the freeze-drying process is disclosed. The food preparation device includes a handle configured to be gripped by a user and a yoke connected to the handle and extending outward to support a piercing assembly. The piercing assembly includes a plurality of rotatable star-shaped wheels mounted on an axle within the yoke, the star-shaped wheels configured to pierce a food item when the device is rolled over the food item. A comb is positioned adjacent to the plurality of star-shaped wheels, wherein the comb is angled to facilitate automatic removal of the food item from the plurality of star-shaped wheels without crushing or deforming the food item.

In some aspects, the handle is ergonomically shaped to enhance user comfort and reduce hand fatigue.

In some aspects, the yoke is made from stainless steel or another corrosion-resistant material for food safety and durability.

In some aspects, the axle supporting the star-shaped wheels is removable to allow for cleaning and maintenance.

In some aspects, the star-shaped wheels are arranged in a staggered pattern to optimize piercing efficiency across different food sizes.

In some aspects, the spacing between the star-shaped wheels is adjustable to accommodate different food textures and sizes.

In some aspects, the comb comprises multiple tines arranged at a predetermined angle to ensure gentle removal of food from the star-shaped wheels.

In some aspects, the comb is detachable and replaceable for customization based on the type of food being processed.

In some aspects, the star-shaped wheels are designed to rotate freely on the axle to minimize drag and resistance.

In some aspects, the device is operable in the forward rolling direction to enhance usability.

In some aspects, the device further comprises an adjustable locking mechanism to secure the comb in place at different angles.

The present invention relates to a hand-operated food preparation device designed for use in freeze-drying and dehydrating processes. The device efficiently pierces the skin of fruits, vegetables, and other produce to facilitate the escape of moisture during sublimation, ensuring a faster and more uniform drying process. This invention integrates both piercing and automatic food removal mechanisms, eliminating the need for manual puncturing and reducing the risk of damaging the natural shape of the food.

The device consists of an ergonomic which allows the user to comfortably grip and control the device. Attached to the handle is a yoke that supports a rotatable axle equipped with a plurality of star wheels. These star wheels feature multiple pointed projections designed to puncture the outer layer of food when the device is rolled over its surface. The star wheels are spaced apart in an adjustable manner to accommodate different food sizes and textures.

Unlike conventional devices that require food to be manually removed after piercing, this device incorporates an angled comb mechanism that automatically disengages food from the star wheels without crushing it. The comb is adjustable, allowing it to be positioned at various angles to optimize food removal efficiency. Additionally, the comb is detachable and replaceable, enabling customization for different food types.

The construction materials of the device ensure durability and food safety. The yoke and handle are preferably made of stainless steel or another corrosion-resistant material, ensuring long-term usability. The star wheels are also made of hardened stainless steel to maintain sharpness over extended use. To prevent food from sticking to the wheels, the blades may be coated with a non-stick material, further enhancing operational efficiency.

To improve usability, the axle supporting the star wheels is removable, allowing for easy cleaning and maintenance. The star wheels rotate freely on the axle to minimize resistance, ensuring smooth and effortless operation. Additionally, the device is designed to function in the forward rolling direction, making it more versatile than existing solutions.

The device is particularly well-suited for freeze-drying applications but can also be utilized for dehydration processes and other food preparation methods. Its adjustable tensioning element allows users to modify the force applied during food removal, making it adaptable for delicate and firm food items alike. The comb flexes slightly, allowing it to accommodate different food sizes without causing deformation.

By providing a comprehensive food preparation solution, this invention significantly reduces manual labor, increases efficiency, and ensures uniformity in food processing. Unlike conventional methods, which require individual hand-piercing of fruits and vegetables, this device automates the process while maintaining the natural integrity of the food item. The adjustable, removable, and durable components make it suitable for both home and commercial applications, providing a unique and innovative solution for the food processing industry.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1A illustrates a perspective view of the food preparation device, according to some embodiments;

FIG. 1B illustrates a top plan view of the food preparation device, according to some embodiments;

FIG. 1C illustrates a side elevation view of the food preparation device, according to some embodiments; and

FIG. 1D illustrates a perspective view of the comb of the food preparation device, according to some embodiments.

### DETAILED DESCRIPTION

The specific details of the single embodiment or variety of embodiments described herein are set forth in this application. Any specific details of the embodiments described herein are used for demonstration purposes only, and no unnecessary limitation(s) or inference(s) are to be understood or imputed therefrom.

Before describing in detail exemplary embodiments, it is noted that the embodiments reside primarily in combinations of components related to particular devices and systems. Accordingly, the device components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments provided herein relate to a food preparation device for use in preparing food during the freeze-drying process is disclosed. The food preparation device includes a handle configured to be gripped by a user and a yoke connected to the handle and extending outward to support a piercing assembly. The piercing assembly includes a plurality of rotatable star-shaped wheels mounted on an axle within the yoke, the star-shaped wheels configured to pierce a food item when the device is rolled over the food item. A comb is positioned adjacent to the plurality of star-shaped wheels, wherein the comb is angled to facilitate automatic removal of the food item from the plurality of star-shaped wheels without crushing or deforming the food item.

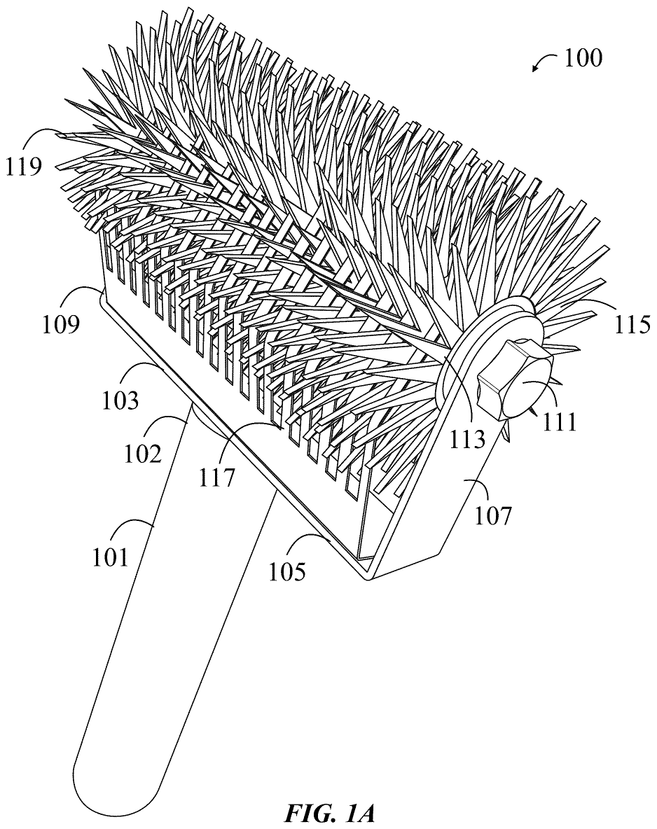

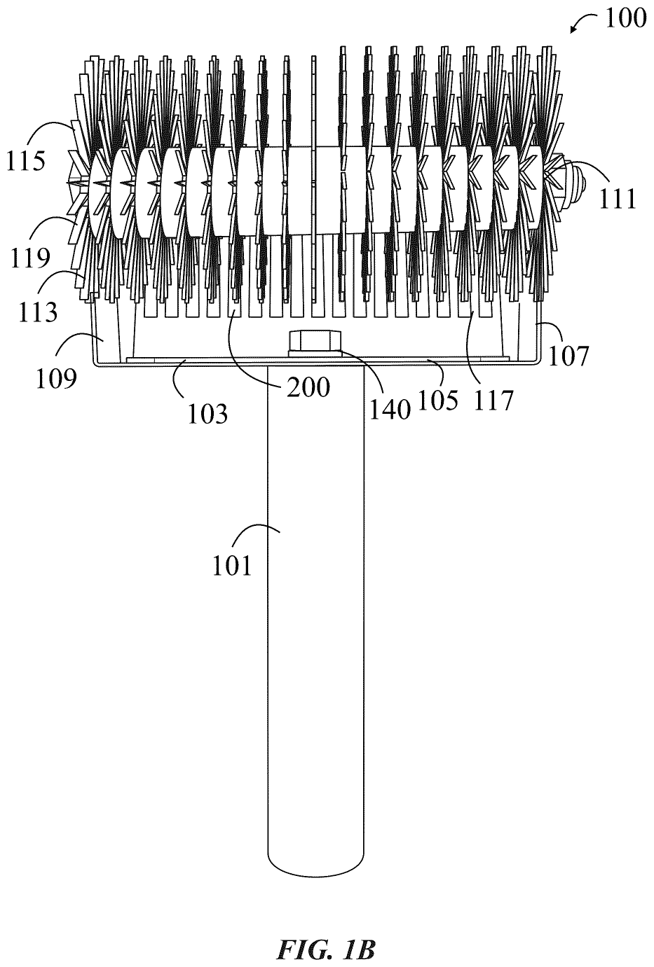

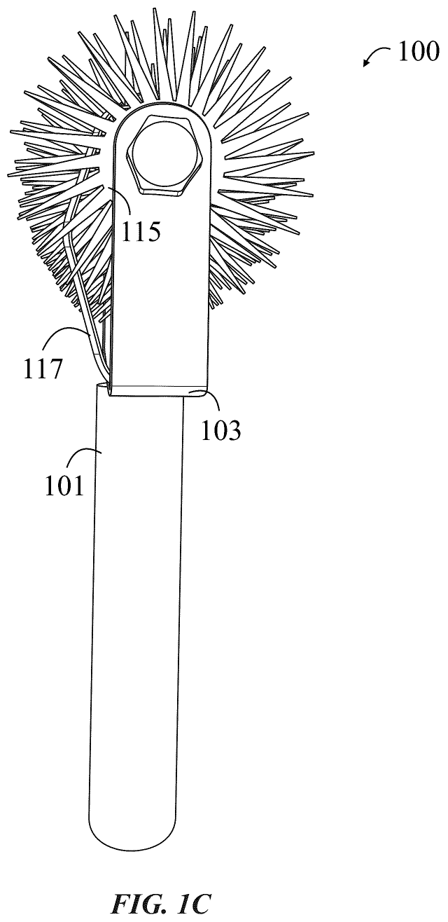

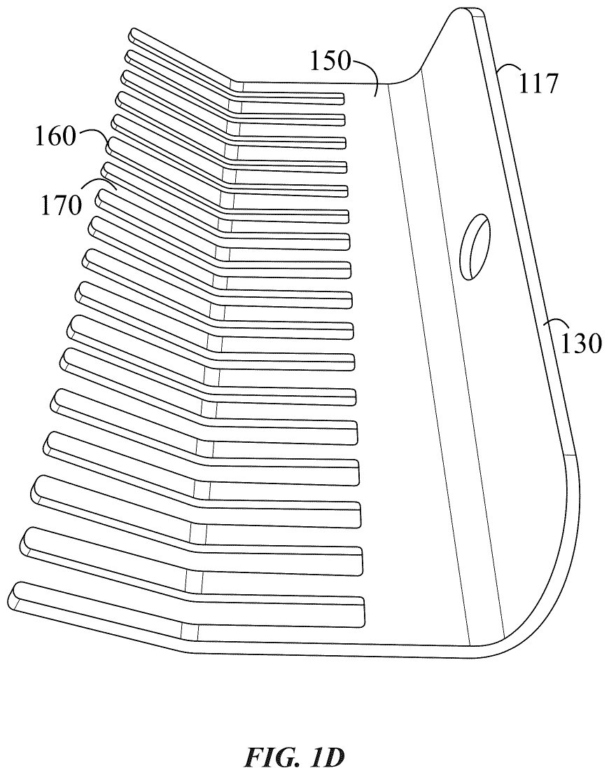

FIGS. 1A-1C illustrate the food preparation device 100 including a handle 101 configured to be gripped by a user. The handle 101 connects to a yoke 103 and extends perpendicular along a main body portion 105 of the yoke 103 from the handle 101. The handle 101 and yoke 103 comprise a frame 102. The yoke 103 include a first arm 107 and a second arm 109 which each connect to an axle 111 to support a piercing assembly 113. The piercing assembly 113 include a plurality of star-shaped wheels 115 configured to pierce a food item when the device 100 is rolled over the food items. A comb 117 is positioned adjacent to the plurality of star-shaped wheels 115 to facilitate automatic removal of the food item from the each of a plurality of pointed projections 119 which form the star-shaped wheels 115.

In specific reference to FIG. 1B, as the piercing assembly 113 rotates having food items pierced onto the plurality of pointed projections 119, each pointed projection 119 will rotate through openings 200 on the comb 117 causing the food item to be removed from the piercing assembly 113. This causes the food items to fall off the piercing assembly 113 onto a collection tray or other collection vessel/surface.

FIG. 1D illustrates a perspective view of the comb 117 which is configured as a food removable mechanism 130 when attached to the frame and star-shaped wheels thereof. The comb 117 includes a main body portion 150 and a plurality of protrusions 160 having openings 170 therebetween. The star-shaped wheels pass through the openings 170 causing the food items to be removed from the pointed projections and released onto a collection area.

In some embodiments, the comb 117 may be flexible to accommodate food items of various sizes and shapes. The comb 117 may also be replaceable to allow for combs 117 having various sizes, shapes and configurations used to accommodate various food items.

In some embodiments, the food removal mechanism 130 includes a tensioning element that adjusts the force applied to the food items during their removal.

In some embodiments, the device 100 includes an adjustable locking mechanism 140 (see FIG. 1B) to secure the comb 117 in place at various angles. The adjustable locking mechanism 140 also allows for the comb to be removed and replaced depending on the specific application of the device and particular food items being prepared for freeze-drying.

Unless otherwise defined, all technical and scientific terms used herein have the same meaning as commonly understood by one of ordinary skill in the art to which this invention belongs. All publications, patent applications, patents, and other references mentioned herein are incorporated by reference in their entirety to the extent allowed by applicable law and regulations. The systems and methods described herein may be embodied in other specific forms without departing from the spirit or essential attributes thereof, and it is therefore desired that the present embodiment be considered in all respects as illustrative and not restrictive. Any headings utilized within the description are for convenience only and have no legal or limiting effect.

Many different embodiments have been disclosed herein, in connection with the above description and the drawings. It will be understood that it would be unduly repetitious and obfuscating to literally describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

The foregoing is provided for purposes of illustrating, explaining, and describing embodiments of this disclosure. Modifications and adaptations to these embodiments will be apparent to those skilled in the art and may be made without departing from the scope or spirit of this disclosure.

As used herein and in the appended claims, the singular forms “a”, “an”, and “the” include plural referents unless the context clearly dictates otherwise.

It should be noted that all features, elements, components, functions, and steps described with respect to any embodiment provided herein are intended to be freely combinable and substitutable with those from any other embodiment. If a certain feature, element, component, function, or step is described with respect to only one embodiment, then it should be understood that that feature, element, component, function, or step can be used with every other embodiment described herein unless explicitly stated otherwise. This paragraph therefore serves as antecedent basis and written support for the introduction of claims, at any time, that combine features, elements, components, functions, and steps from different embodiments, or that substitute features, elements, components, functions, and steps from one embodiment with those of another, even if the description does not explicitly state, in a particular instance, that such combinations or substitutions are possible. It is explicitly acknowledged that express recitation of every possible combination and substitution is overly burdensome, especially given that the permissibility of each and every such combination and substitution will be readily recognized by those of ordinary skill in the art.

In many instances entities are described herein as being coupled to other entities. It should be understood that the terms “coupled” and “connected” (or any of their forms) are used interchangeably herein and, in both cases, are generic to the direct coupling of two entities (without any non-negligible (e.g., parasitic intervening entities) and the indirect coupling of two entities (with one or more non-negligible intervening entities). Where entities are shown as being directly coupled together or described as coupled together without description of any intervening entity, it should be understood that those entities can be indirectly coupled together as well unless the context clearly dictates otherwise.

While the embodiments are susceptible to various modifications and alternative forms, specific examples thereof have been shown in the drawings and are herein described in detail. It should be understood, however, that these embodiments are not to be limited to the particular form disclosed, but to the contrary, these embodiments are to cover all modifications, equivalents, and alternatives falling within the spirit of the disclosure. Furthermore, any features, functions, steps, or elements of the embodiments may be recited in or added to the claims, as well as negative limitations that define the inventive scope of the claims by features, functions, steps, or elements that are not within that scope.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described herein. A variety of modifications and variations are possible in light of the above teachings without departing from the following claims.

What is claimed is:

1. A food preparation device, comprising:
a handle configured to be gripped by a user;
a yoke connected to the handle and extending outward to support a piercing assembly;
a plurality of rotatable star-shaped wheels mounted on an axle within the yoke, the star-shaped wheels configured to pierce a food item when the device is rolled over the food item; and
a comb positioned adjacent to the plurality of star-shaped wheels, wherein the comb is angled to facilitate automatic removal of the food item from the plurality of star-shaped wheels without crushing or deforming the food item.

2. The food preparation device of claim 1, wherein the handle is ergonomically shaped to enhance user comfort and reduce hand fatigue.

3. The food preparation device of claim 1, wherein the yoke is made from stainless steel or another corrosion-resistant material for food safety and durability.

4. The food preparation device of claim 1, wherein the axle supporting the star-shaped wheels is removable to allow for cleaning and maintenance.

5. The food preparation device of claim 1, wherein the star-shaped wheels are arranged in a staggered pattern to optimize piercing efficiency across different food sizes.

6. The food preparation device of claim 1, wherein the spacing between the star-shaped wheels is adjustable to accommodate different food textures and sizes.

7. The food preparation device of claim 1, wherein the comb comprises multiple tines arranged at a predetermined angle to ensure gentle removal of food from the star-shaped wheels.

8. The food preparation device of claim 1, wherein the comb is detachable and replaceable for customization based on the type of food being processed.

9. The food preparation device of claim 1, wherein the star-shaped wheels are designed to rotate freely on the axle to minimize drag and resistance.

10. The food preparation device of claim 1, wherein the device is operable in the forward rolling direction to enhance usability.

11. The food preparation device of claim 1, wherein the device further comprises an adjustable locking mechanism to secure the comb in place at different angles.

12. A food preparation device, comprising:
a handle to enable manual operation;
a frame supporting an axle to hold a plurality of interspaced star-shaped wheels, the star-shaped wheels constructed of a plurality of pointed projections designed to puncture a food item as the device is rolled over the food item;
a comb configured as a food removal mechanism to remove the food item from the plurality of star-shaped wheels.

13. The food preparation device of claim 12, wherein the star-shaped wheels are made from hardened stainless steel to maintain sharpness and efficiency over prolonged use.

14. The food preparation device of claim 12, wherein the pointed projections on the star-shaped wheels are shaped to minimize resistance while puncturing food surfaces.

15. The food preparation device of claim 12, wherein the removal mechanism includes a tensioning element that adjusts the force applied to the food during removal.

16. A hand-operated device for preparing food for freeze drying, comprising:
a frame including a handle and a yoke;
a plurality of rotatable star-shaped blades configured to penetrate an outer layer of a produce item;
a comb positioned adjacent to the plurality of rotatable star-shaped blades, the comb to dislodge the produce item from the plurality of rotatable star-shaped blades.

17. The device of claim 16, wherein the handle and yoke assembly is designed to distribute pressure evenly to ensure consistent penetration of the food's surface.

18. The device of claim 16, wherein the comb flexes to accommodate different food sizes.

19. The device of claim 16, wherein the blades are coated with a non-stick material to prevent food from adhering to them during operation.

20. The device of claim 16, wherein the device is configured for use with freeze-dried food preparation as well as dehydrated food processing.
